(19) United States
(12) Patent Application Publication
(10) Pub. No.: US 2025/0291283 A1
(43) Pub. Date: Sep. 18, 2025

(54) FIXING DEVICE AND IMAGE FORMING APPARATUS

(71) Applicant: FUJIFILM Business Innovation Corp., Tokyo (JP)

(72) Inventors: Kosuke YAMADA, Kanagawa (JP); Takayuki YAMASHITA, Kanagawa (JP); Haruka KOBAYASHI, Kanagawa (JP)

(73) Assignee: FUJIFILM Business Innovation Corp., Tokyo (JP)

(21) Appl. No.: 18/754,185

(22) Filed: Jun. 26, 2024

(30) Foreign Application Priority Data
Mar. 13, 2024 (JP) 2024-039285

(51) Int. Cl. G03G 15/20

(52) U.S. Cl. CPC G03G 15/2007

(57) ABSTRACT

A fixing device includes a light source unit that applies light to a surface of a can accommodating a content so that an image formed on the surface is fixed by heat of the light and a reflection portion that reflects the light from the light source unit to a predetermined area on the surface of the can.

### CROSS-REFERENCE TO RELATED APPLICATIONS

This application is based on and claims priority under 35 USC 119 from Japanese Patent Application No. 2024-039285 filed Mar. 13, 2024.

### BACKGROUND

### (i) Technical Field

The present invention relates to a fixing device and an image forming apparatus.

### (ii) Related Art

For example, disclosed in JP1994-99571A is a configuration in which an image developed on a photoreceptor is transferred to a peripheral surface of a tubular body and the tubular body to which the image is transferred is heated so that the image is fixed and a printing tubular body is manufactured.

### SUMMARY

Here, in a case where light is applied to a surface of a can in a state where a content is accommodated in the can so that an image is fixed onto the surface by the heat of the light, the temperature of the content may increase together with the temperature of the surface of the can and a decrease in quality of the content may occur in a case where a region to which light is applied is not limited.

Aspects of non-limiting embodiments of the present disclosure relate to a fixing device and image forming apparatus that suppress, in comparison with a case where a region on a surface of a can to which light is applied is not limited, an increase in temperature of a content in the can that occurs in the case of fixation of an image onto the surface of the can.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a fixing device including a light source unit that applies light to a surface of a can accommodating a content so that an image formed on the surface is fixed by heat of the light and a reflection portion that reflects the light from the light source unit to a predetermined area on the surface of the can.

### BRIEF DESCRIPTION OF THE DRAWINGS

Exemplary embodiment(s) of the present invention will be described in detail based on the following figures, wherein:

FIG. 1 is a view showing an image forming apparatus to which the present exemplary embodiment is applied;

FIG. 2 is a view showing a configuration of a transfer cylinder to which the present exemplary embodiment is applied;

FIGS. 3A to 3C are views showing the way in which a transport mechanism operates before image formation performed by the transfer unit is started, FIG. 3A is a view showing a state where height control is performed, FIG. 3B is a view showing a state where the transport mechanism has been withdrawn to a preparation position after the height control, and FIG. 3C is a view showing a state where transfer of an image is started by the transfer unit;

FIGS. 4A to 4C are views showing a method of transferring an image to a medium including a circumferential surface, FIG. 4A is a view showing a state at the start of transfer, FIG. 4B is a view showing a state during the transfer, and FIG. 4C is a view showing a state at the end of the transfer;

FIGS. 5A and 5B are views showing the configuration and operation of a fixation unit, FIG. 5A is a view showing a state where an opening portion of the fixation unit is open and FIG. 5B is a view showing a state where the opening portion of the fixation unit is closed;

FIGS. 6A and 6B are a view and a graph for description of a first configuration example of a heat source according to the present exemplary embodiment, FIG. 6A is a view showing a light source and the like serving as the heat source provided in the fixation unit together with a medium, and FIG. 6B is a graph showing a relationship between a heating time and the surface temperature of the medium;

FIGS. 7A and 7B are a view and a graph for description of a predetermined area on an outer peripheral surface of the medium, FIG. 7A is a view for description of the predetermined area, and FIG. 7B is a graph showing a relationship between the proportion of a content in the medium and an angle;

FIGS. 8A to 8C are a view and time charts for description of a second configuration example of the heat source according to the present exemplary embodiment, FIG. 8A is a view showing the light source and the like serving as the heat source together with the medium, and FIGS. 8B and 8C are time charts showing operation examples of a motor for rotation of the medium;

FIGS. 9A and 9B are views for description of a third configuration example of the heat source according to the present exemplary embodiment, FIG. 9A is a view showing a reflection plate constituting a portion of the heat source together with a medium, and FIG. 9B is a view showing a reflection plate constituting a portion of the heat source together with a medium;

FIGS. 10A and 10B are a view and a time chart for description of a first modification example of the present exemplary embodiment, FIG. 10A is a view showing a configuration in the first modification example, and FIG. 10B is a time chart showing operation examples of motors; and

FIG. 11 is a view showing a configuration in a second modification example of the present exemplary embodiment.

### DETAILED DESCRIPTION

Hereinafter, an exemplary embodiment of the present invention will be described in detail with reference to the accompanying drawings.

An image forming apparatus of the present exemplary embodiment is an image forming apparatus for digital printing. Although examples of a printing method for digital printing include an electrophotographic printing method and an ink jet printing method, the present exemplary embodiment is based on the assumption that the electrophotographic printing method is used. In the case of the electrophotographic printing method, a transfer unit and a medium come into contact with each other in a case where an image is transferred to the medium. In addition, the present exemplary embodiment is based on the assumption that printing is performed on mediums having various thicknesses and shapes, the various mediums being formed of metal, glass, or a tile.

### Configuration of Apparatus

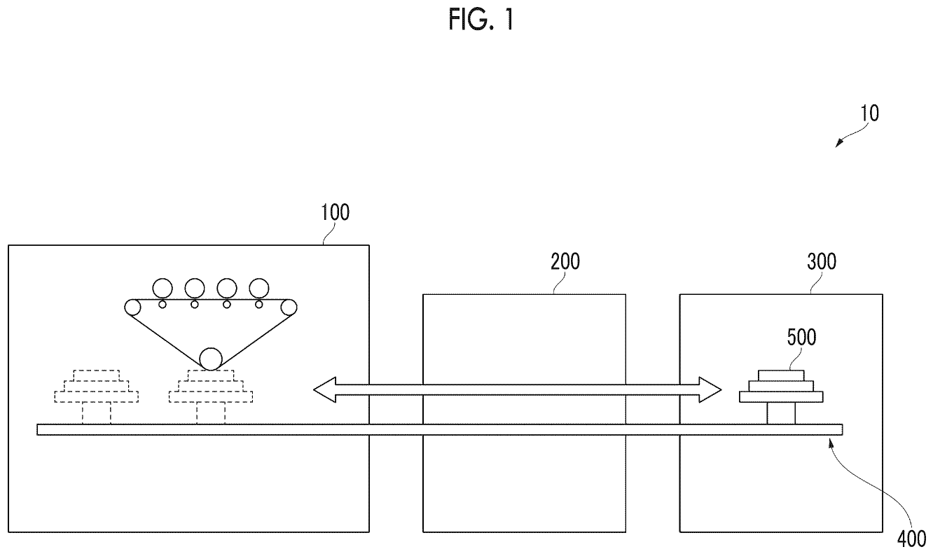

FIG. 1 is a view showing a configuration of an image forming apparatus 10 to which the present exemplary embodiment is applied.

As shown in FIG. 1, the image forming apparatus 10 includes a transfer unit 100, a fixation unit 200, a medium attachment and detachment unit 300, and a transport mechanism 400.

In addition, although not particularly shown in the drawings, the image forming apparatus 10 includes a control unit that includes one or a plurality of processors which are means for arithmetic operations, a memory serving as a work area in data processing, a storage device that holds a program or data, and the like. The control unit may be a single control unit that controls the operation of the entire image forming apparatus 10, or may be provided for each of the transfer unit 100, the fixation unit 200, the transport mechanism 400, and the like.

The transfer unit 100 is a unit that transfers, to a medium 500, an image formed by toner particles or the like.

The fixation unit 200 is a unit that heats the medium 500 so that the image transferred by the transfer unit 100 is fixed to a surface of the medium 500.

The medium attachment and detachment unit 300 is a unit at which a user of the image forming apparatus 10 attaches the medium 500 to an attachment table (which will be described later) provided at the transport mechanism 400.

The transport mechanism 400 is provided over all of the transfer unit 100, the fixation unit 200, and the medium attachment and detachment unit 300 and transports the medium 500, on which printing is performed, to each of the transfer unit 100, the fixation unit 200, and the medium attachment and detachment unit 300 as represented by an arrow in FIG. 1.

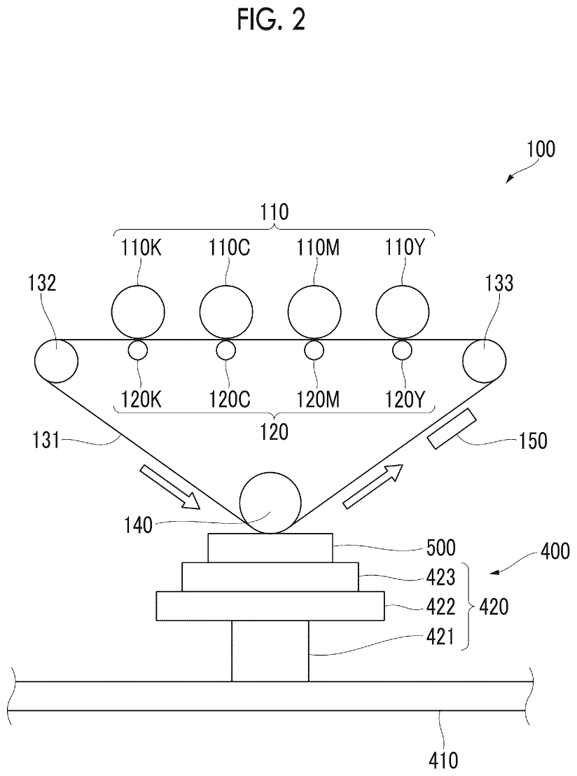

The medium attachment and detachment unit 300 is a housing of which a portion is provided with an opening through which the medium 500 can enter and exit the housing. In addition, as will be described in detail later, one end-side portion of a transport rail 410 (refer to FIG. 2) constituting the transport mechanism 400 is in the medium attachment and detachment unit 300 and a transport start position and a transport end position are set in the medium attachment and detachment unit 300. In the present exemplary embodiment, the transport start position and the transport end position are set to the same place. In an initial state, an attachment table 420 (refer to FIG. 2) that constitutes the transport mechanism 400 is disposed at a place on the transport rail 410 that is set as the transport start position and the transport end position. In a case where the user inserts a jig 423 holding the medium 500 through the opening of the housing of the medium attachment and detachment unit 300 and mounts the jig 423 to the attachment table 420, the medium 500 becomes able to be transported by the transport mechanism 400. After an image is transferred to the medium 500 by the transfer unit 100 and a fixation process is performed by the fixation unit 200, the attachment table 420 with the medium 500 placed thereon moves along the transport rail 410 and reaches the transport end position. In such a state, the user removes the jig 423 holding the medium 500 from the attachment table 420 and extracts the jig 423 through the opening of the housing of the medium attachment and detachment unit 300.

### Configuration of Transfer Unit 100

FIG. 2 is a view showing a configuration of the transfer unit 100 to which the present exemplary embodiment is applied.

As shown in FIG. 2, the transfer unit 100 forms an image by means of charged particles and generates an electric field to transfer an image to the medium 500. The transfer unit 100 includes development devices 110, primary transfer rolls 120, and an intermediate transfer belt 131. The intermediate transfer belt 131 is stretched, by rollers 132 and 133 and a backup roll 140, between the development devices 110 and a position at which transfer to the medium 500 is performed.

In addition, the transfer unit 100 includes a cleaning device 150 removing particles adhering to the intermediate transfer belt 131.

The development devices 110 are units each of which forms, on a photoreceptor, an electrostatic latent image of an image to be transferred and develops the image by causing charged particles to adhere to the electrostatic latent image on the photoreceptor. As the development devices 110, existing devices used in an electrophotographic image forming apparatus may be used. FIG. 2 shows a configuration example related to a case where a color image forming process, in which four colors including black in addition to three colors of yellow, magenta, and cyan are used, is performed. The development device 110 is provided for each of these colors and in FIG. 2, the development devices 110 for yellow, magenta, cyan, and black are respectively shown with letters “Y”, “M”, “C”, and “K” added thereto, the letters representing the colors corresponding to the development devices 110. In the following description, the description will be made with the letters “Y”, “M”, “C”, and “K” added to reference numerals in a case where the colors are to be distinguished therebetween regarding the development devices 110. However, in a case where the colors do not need to be distinguished therebetween, the description will be made without the letters added thereto.

The primary transfer rolls 120 are units used to transfer images formed at the development devices 110 to the intermediate transfer belt 131. The primary transfer rolls 120 are disposed to face the photoreceptors of the development devices 110, and are configured such that the intermediate transfer belt 131 is positioned between the development devices 110 and the primary transfer rolls 120. The primary transfer rolls 120 are provided to respectively correspond to the development devices 110Y, 110M, 110C, and 110K. In FIG. 2, the primary transfer rolls 120 corresponding to the development devices 110Y, 110M, 110C, and 110K for the respective colors are respectively shown with letters “Y”, “M”, “C”, and “K” added thereto, the letters representing the colors corresponding to the primary transfer rolls 120. In the following description, the description will be made with the letters “Y”, “M”, “C”, and “K” added to reference numerals in a case where the colors are to be distinguished therebetween regarding the primary transfer rolls 120. However, in a case where the colors do not need to be distinguished therebetween, the description will be made without the letters added thereto.

The intermediate transfer belt 131, the rollers 132 and 133, and the backup roll 140 are units used to transfer the image formed at the development devices 110 to the medium 500. As shown in FIG. 2, the intermediate transfer belt 131 rotates in a direction along arrows in FIG. 2 (a counterclockwise direction in an example shown in the drawing) in a state of being hung on the rollers 132 and 133 and the backup roll 140 and stretched. The rotation of the intermediate transfer belt 131 is performed, for example, by using one or both of the rollers 132 and 133 as rotationally driving rollers and pulling the intermediate transfer belt 131 by means of rotation of the rollers.

In the configuration example of FIG. 2, an outer surface of the intermediate transfer belt 131 is a transfer surface which is a surface at which an image is held. In a case where the intermediate transfer belt 131 passes through a space between the development devices 110 and the primary transfer rolls 120, images are transferred from the photoreceptors of the development devices 110 to the transfer surface of the intermediate transfer belt 131. In the configuration example shown in FIG. 2, a yellow (Y) image, a magenta (M) image, a cyan (C) image, and a black (K) image are superimposed on the transfer surface by the development devices 110Y, 110M, 110C, and 110K and the primary transfer rolls 120Y, 120M, 120C, and 120K, so that a multicolor image is formed.

The backup roll 140 brings the transfer surface of the intermediate transfer belt 131 into contact with the medium 500 so that the image is transferred to the medium 500. Such transfer is secondary transfer. A predetermined voltage is applied to the backup roll 140 in the case of secondary transfer of the image. Accordingly, an electric field, that is, a transfer electric field is generated in an area including the backup roll 140 and the medium 500, and an image formed by charged particles is transferred from the intermediate transfer belt 131 to the medium 500. For secondary transfer of an image from the intermediate transfer belt 131 to the medium 500 as described above, a current needs to flow from the backup roll 140 to the medium 500 via the intermediate transfer belt 131. Here, in a case where the medium 500 is a conductor such as metal, the image is secondary-transferred to a surface of the medium 500 as a transfer electric field is generated since a current flows through the medium 500 itself. Meanwhile, in a case where the medium 500 is not a conductor, the image cannot be secondary-transferred as it is because no current flows through the medium. Therefore, in a case where a material that is not a conductor is used as the medium 500, a conductive layer which is a layer formed of a conductive material is formed or the like at least on an image formation target region of a surface of the medium 500 in advance so that a current flows through the medium 500.

A procedure for image transfer performed by means of the intermediate transfer belt 131 will be described.

In a case where the intermediate transfer belt 131 is rotated, a yellow (Y) image, a magenta (M) image, a cyan (C) image, and a black (K) image are sequentially superimposed on the transfer surface (the outer surface in FIG. 2) of the intermediate transfer belt 131 by the development devices 110Y, 110M, 110C, and 110K and the primary transfer rolls 120Y, 120M, 120C, and 120K, so that a multicolor image is formed.

In a case where the intermediate transfer belt 131 is further rotated, the image formed on the transfer surface of the intermediate transfer belt 131 reaches a transfer position which is a position where the intermediate transfer belt 131 comes into contact with the medium 500. Then, as described above, a voltage is applied to the backup roll 140 so that a transfer electric field is generated and the image is transferred from the intermediate transfer belt 131 to the medium 500. In addition, an advance direction of the intermediate transfer belt 131 at the transfer position is parallel to the direction of transportation of the attachment table 420 that is performed by the transport mechanism 400 and the advance direction coincides with the direction of transportation in the case of transfer of an image onto the medium 500.

The cleaning device 150 is a unit that removes particles adhering to the transfer surface of the intermediate transfer belt 131. The cleaning device 150 is provided downstream of the transfer position and is provided upstream of the development device 110Y and the primary transfer roll 120Y in the direction of rotation of the intermediate transfer belt 131. Accordingly, particles remaining on the transfer surface of the intermediate transfer belt 131 are removed by the cleaning device 150 after an image is transferred from the intermediate transfer belt 131 to the medium 500. Then, in the next operation cycle, an image is newly transferred (primary transfer) to the transfer surface from which the particles have been removed.

### Configuration of Transport Mechanism 400 and Attachment Structure for Medium 500

Here, an attachment structure for the medium 500 will be described. The present exemplary embodiment is based on the assumption that the mediums 500 having various thicknesses and shapes are used. In a case where the mediums 500 are transported after being directly placed on a transport path composed of a belt or a roller and the mediums 500 have different thicknesses or shapes, it is difficult to bring the intermediate transfer belt 131 into contact with the mediums 500 since the heights of the mediums 500 with respect to the transport path are different from each other at the transfer position of the transfer unit 100. Specifically, the medium 500 does not come into contact with the intermediate transfer belt 131 in a case where the height of the medium 500 is small and a strong impact may occur in the case of contact between the medium 500 and the intermediate transfer belt 131 in a case where the height of the medium 500 is large. Therefore, in the case of the transport mechanism 400 of the present exemplary embodiment, the medium 500 is placed on the attachment table 420 including height control means and the medium 500 is transported together with the attachment table 420.

Referring to FIG. 2, the transport mechanism 400 includes the transport rail 410 that specifies a transport route of the medium 500 and the attachment table 420 that moves on the transport rail 410. The attachment table 420 includes a leg portion 421 attached to the transport rail 410 and a pedestal portion 422 on which the medium 500 is placed. In addition, a jig 423 that holds the medium 500 on the pedestal portion 422 is attached to the pedestal portion 422.

In a configuration example shown in FIG. 1, the transport rail 410 is installed across an area from the medium attachment and detachment unit 300 to the transfer unit 100 with the fixation unit 200 interposed therebetween. An end portion of the transport rail 410 that is on the medium attachment and detachment unit 300 side is the transport start position and is the transport end position. The attachment table 420 is transported leftward in FIG. 1 from the transport start position of the medium attachment and detachment unit 300, and an image is transferred to the medium 500 in the transfer unit 100. The attachment table 420 is transported rightward in FIG. 1 after the transfer of the image, and the attachment table 420 reaches the transport end position of the medium attachment and detachment unit 300 after the image is fixed to the medium 500 at the fixation unit 200.

The leg portion 421 is attached to the transport rail 410 and moves on the transport rail 410. A mechanism for movement of the leg portion 421 on the transport rail 410 is not particularly limited. For example, the leg portion 421 may be configured to automatically travel while being provided with a driving device or the transport rail 410 may be provided with a means for pulling the leg portion 421. In addition, the leg portion 421 includes height control means for controlling the height of the pedestal portion 422. The configuration of the height control means is not particularly limited. For example, a configuration in which the pedestal portion 422 is moved upward and downward by a rack-and-pinion and a drive motor may also be adopted. In addition, a configuration in which the height of the pedestal portion 422 is controlled by manually operating a gear linked to the height of the pedestal portion 422 may also be adopted. Furthermore, various methods may be used as an operation method for height control. For example, an input interface for the control unit of the drive motor may be prepared, and an operator of the image forming apparatus 10 may manually input and set height data using the input interface. In addition, a configuration in which the height of the medium 500 attached to the attachment table 420 is automatically detected by means of a sensor and the drive motor is controlled such that the height of the medium 500 becomes an appropriate height may also be adopted.

The pedestal portion 422 is a pedestal that is attached to the leg portion 421 and on which the medium 500 is placed via the jig 423. The pedestal portion 422 is provided with a fastener (not shown) positioning the jig 423. Regardless of the shape of the jig 423 itself, the jig 423 can be positioned and attached to the pedestal portion 422 as long as the jig 423 matches the fastener.

In addition, the pedestal portion 422 is attached to move upward and downward with respect to the leg portion 421 in response to pressure from above. A configuration in which the pedestal portion 422 moves upward and downward is realized with, for example, an elastic body interposed between junction portions of the pedestal portion 422 and the leg portion 421. With such a configuration, an impact in the case of contact between the medium 500 held by the jig 423 attached to the pedestal portion 422 and the intermediate transfer belt 131 of the transfer unit 100 is alleviated.

The jig 423 is a tool that holds the medium 500 and that is attached to the pedestal portion 422. A portion of the jig 423 that is attached to the pedestal portion 422 has a shape or a structure matching the fastener of the pedestal portion 422. In addition, the jig 423 has a shape for holding the medium 500. Therefore, it is possible to place the mediums 500 having various shapes or sizes on the attachment table 420 in a case where the jigs 423 matching the shapes or sizes of the mediums 500 are prepared.

The present exemplary embodiment is based on the assumption that the medium 500 on which an image is formed is the medium 500 including a circumferential surface, and the image is transferred to the circumferential surface of the medium 500 along a circumferential direction by the transfer unit 100. Therefore, as the jig 423, a jig having a function of bringing the circumferential surface of the medium 500 into contact with the intermediate transfer belt 131 of the transfer unit 100 along the circumferential direction is used. Details of the jig 423 as described above will be described later.

### Preliminary Operation for Image Formation

Since the image forming apparatus 10 of the present exemplary embodiment includes the transport mechanism 400 configured as described above, printing can be performed on the mediums 500 having various shapes and sizes. However, the height control of the pedestal portion 422 is performed before an image transfer operation is started in order to prevent a problem in which a strong impact is caused because of contact between the medium 500 and the intermediate transfer belt 131 of the transfer unit 100 in the case of transfer of an image to the medium 500 or the medium 500 and the intermediate transfer belt 131 do not come into contact with each other.

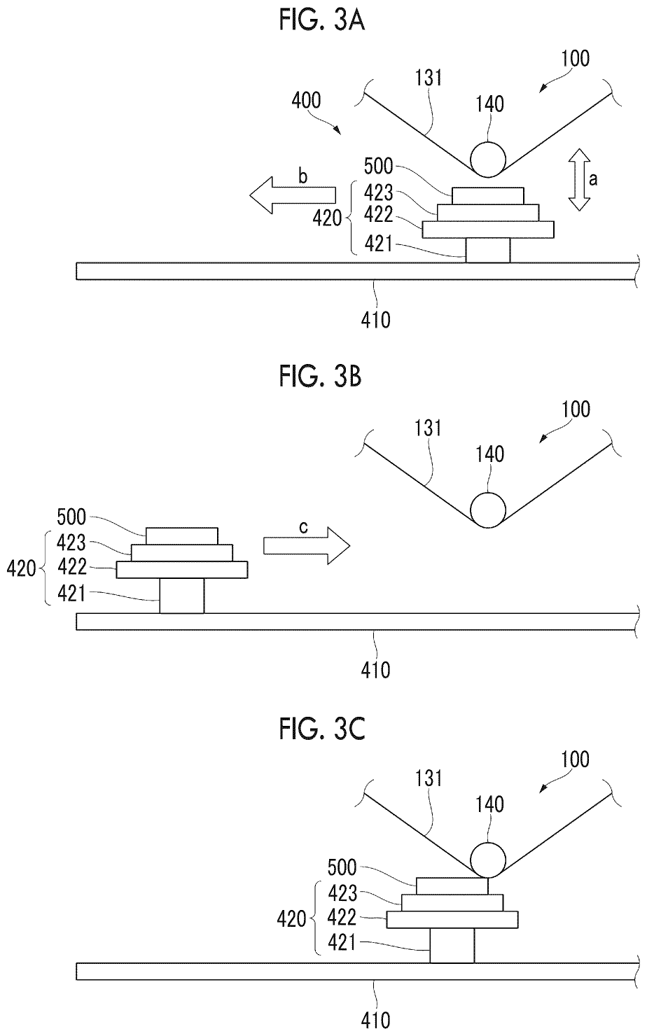

FIGS. 3A to 3C are views showing an operation of the transport mechanism 400 before image formation performed by the transfer unit 100 is started. FIG. 3A is a view showing a state where the height control is performed, FIG. 3B is a view showing a state where the transport mechanism 400 has been withdrawn to a preparation position after the height control, and FIG. 3C is a view showing a state where transfer of an image is started by the transfer unit 100.

In a case where an image is to be formed on the medium 500, first, the medium 500 held by the jig 423 is set on the attachment table 420 at the transport start position of the medium attachment and detachment unit 300. Then, after the medium 500 is lowered by the height control means of the attachment table 420 to a height at which the medium 500 does not come into contact with the intermediate transfer belt 131 of the transfer unit 100, the attachment table 420 with the medium 500 placed thereon moves to a position below the transfer position of the transfer unit 100.

Next, the height of the attachment table 420 is controlled such that the medium 500 is brought into contact with the intermediate transfer belt 131 at the transfer position at an intensity appropriate for image transfer (arrow a in FIG. 3A). In a case where the height control is performed, information about an obtained appropriate height (hereinafter, referred to as a “transfer execution height”) is held in a memory or the like of the control unit. Then, the attachment table 420 is lowered to a height at which the medium 500 does not come into contact with the intermediate transfer belt 131 and moves to a transfer operation preparation position (arrow b in FIG. 3A).

In a case where the attachment table 420 moves to the preparation position, the height of the attachment table 420 is adjusted to the transfer execution height based on the information obtained in the height control. Thereafter, the attachment table 420 moves to the transfer position (arrow c in FIG. 3B) and image transfer is started in a case where the medium 500 comes into contact with the intermediate transfer belt 131 at the transfer position (FIG. 3C).

### Transfer of Image to Medium 500 Including Circumferential Surface

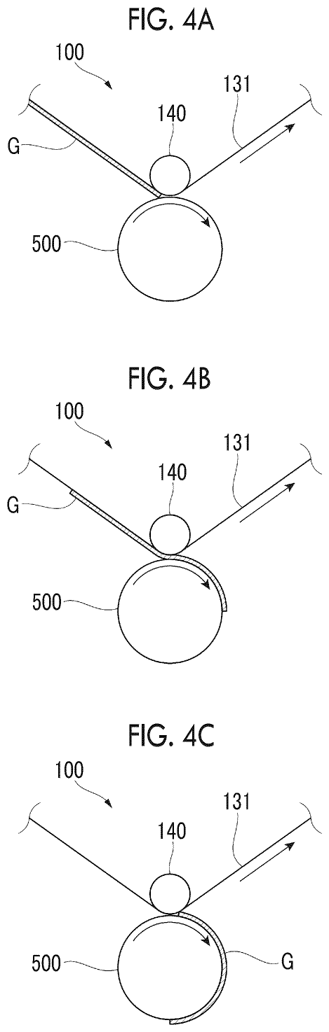

FIGS. 4A to 4C are views showing a method of transferring an image to the medium 500 including a circumferential surface. FIG. 4A is a view showing a state at the start of transfer, FIG. 4B is a view showing a state during the transfer, and FIG. 4C is a view showing a state at the end of the transfer. In an example shown in FIGS. 4A to 4C, a state where an image G is transferred to a side surface of the medium 500 over half of a circumference in a circumferential direction is shown, the medium 500 having a columnar shape.

In a case where the image G is to be formed on the side surface of the medium 500, which is the circumferential surface, along the circumferential direction, a portion of the side surface of the medium 500 that comes into contact with the intermediate transfer belt 131 of the transfer unit 100 needs to move in accordance with advance of the intermediate transfer belt 131 in a state where the medium 500 is stopped at the transfer position of the transfer unit 100. Therefore, the jig 423 (refer to FIG. 3A to 3C) holds the medium 500 such that a central axis of the circumferential surface of the medium 500 is orthogonal to an advance direction (hereinafter, referred to as a “transfer direction”) of the intermediate transfer belt 131 at the transfer position, and the medium 500 is rotated around the central axis. The direction of rotation of the medium 500 is a direction in which an advance of the circumferential surface coincides with the transfer direction of the intermediate transfer belt 131 at a position at which the intermediate transfer belt 131 and the circumferential surface of the medium 500 come into contact with each other. In an example shown in FIGS. 4A to 4C, the medium 500 is shown with the central axis of the circumferential surface extending in a direction perpendicular to the paper surface. In addition, the intermediate transfer belt 131 advances from a left side to a right side in the drawing and the medium 500 rotates clockwise in the drawing (refer to an arrow in the drawing).

In a case where the transfer unit 100 transfers the image G to the medium 500, first, the image G is formed on the intermediate transfer belt 131 by the development devices 110 of the respective colors as the intermediate transfer belt 131 advances. In addition, in a case where the intermediate transfer belt 131 further advances and the image G formed on the intermediate transfer belt 131 reaches the transfer position, the image G is transferred to the medium 500 from the intermediate transfer belt 131 as shown in FIG. 4A. In a case where the intermediate transfer belt 131 further advances, the medium 500 rotates and transfer of the image G is performed with a contact portion of the medium 500 moving along the circumferential direction. Therefore, as shown in FIGS. 4B and 4C, the image G on the intermediate transfer belt 131 is transferred to the circumferential surface of the medium 500 along the circumferential direction.

### Configuration of Fixation Unit 200

In a case where an image is transferred to the medium 500 in the transfer unit 100, the image is fixed at the fixation unit 200 thereafter. In the present exemplary embodiment, a fixation process is performed by a non-contact type device so that images are formed on the mediums 500 having various thicknesses and shapes. The fixation unit 200 heats and melts particles forming the image transferred to the medium 500 to fix the particles to a surface of the medium 500.

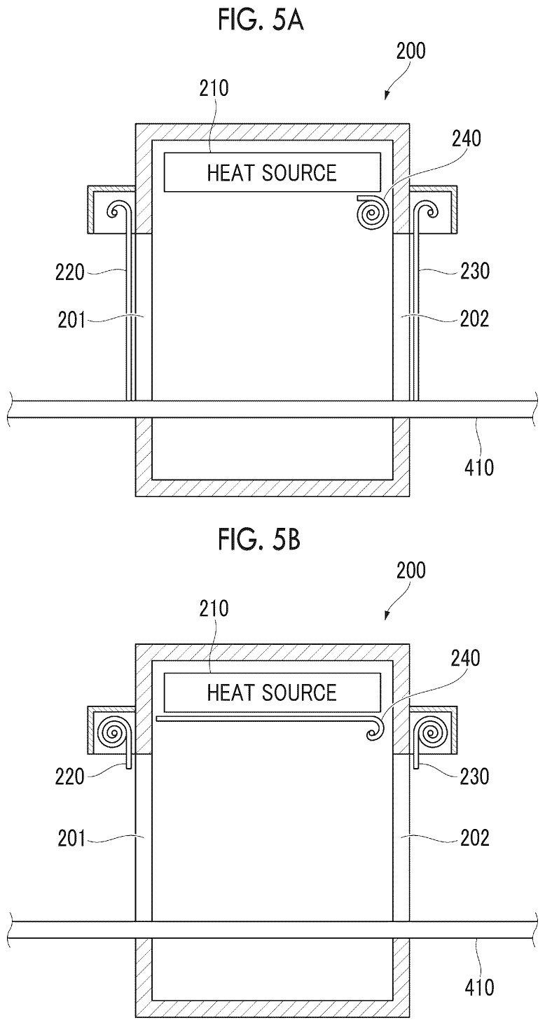

FIGS. 5A and 5B are views showing a configuration of the fixation unit 200 and the way in which the fixation unit 200 operates. FIG. 5A is a view showing a state where an opening portion of the fixation unit 200 is closed, and FIG. 5B is a view showing a state where the opening portion of the fixation unit 200 is open. The fixation unit 200 includes an inlet port 201 which is an opening portion through which the medium 500 is carried in and an outlet port 202 which is an opening portion through which the medium 500 is carried out. In addition, opening and closing members are provided at the inlet port 201 and the outlet port 202 of the fixation unit 200 of the present exemplary embodiment, and the opening and closing members are configured to be opened in a case where the medium 500 is to be carried in and carried out and to be closed in a case where a fixation process is to be performed.

Here, an opening portion on a side where the medium 500 is carried in in a case where a fixation process of an image is performed by the fixation unit 200 is the inlet port 201 and an opening portion on a side where the medium 500 is carried out is the outlet port 202. In other words, an opening portion in a side surface facing the transfer unit 100 is the inlet port 201, and an opening portion in a side surface facing the medium attachment and detachment unit 300 is the outlet port 202. In an example shown in FIGS. 5A and 5B, an opening portion on a left side is the inlet port 201, and an opening portion on a right side is the outlet port 202. Note that in the image forming apparatus 10 of the present exemplary embodiment, the medium 500 passes through the fixation unit 200 in a case where the medium 500 is transported from the transport start position of the medium attachment and detachment unit 300 to the transfer unit 100. In this case, contrary to the case of a fixation process, the medium 500 enters the fixation unit 200 through the outlet port 202 and exits the fixation unit 200 through the inlet port 201. However, in the present exemplary embodiment, the inlet port 201 and the outlet port 202 are set as described above based on the way in which the fixation unit 200 operates in a case where a fixation process is performed in the fixation unit 200.

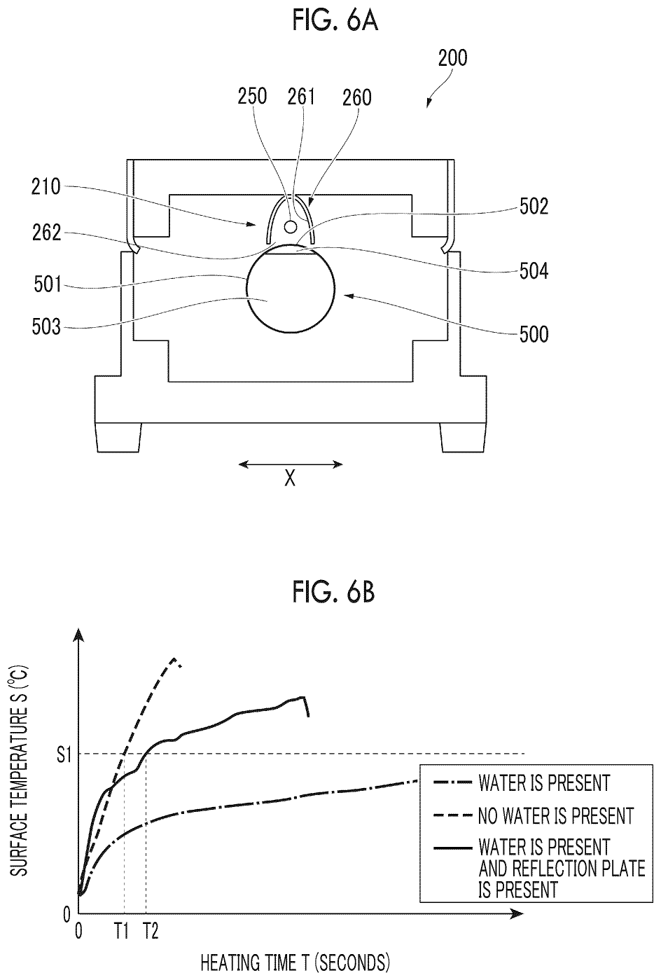

The fixation unit 200 includes a heat source 210 for thermal fixation. As the heat source 210, for example, various existing light sources 250 (refer to FIGS. 6A and 6B) such as a halogen lamp, a ceramic heater, and an infrared lamp may be used. As such a light source 250, a device that heats particles forming an image by irradiating the particles with an infrared laser may also be used. The fixation unit 200 of the present exemplary embodiment has a configuration in which a covering member that can cover the heat source 210 is provided and the heat source 210 is exposed in the case of a fixation process.

In the example shown in FIGS. 5A and 5B, roll-type shutters 220 and 230 are provided as the opening and closing members of the inlet port 201 and the outlet port 202. The shutters 220 and 230 are closed except for a case where the medium 500 is to be carried in and carried out (refer to FIG. 5A) so that a decrease in internal temperature. In addition, the shutter 220 of the inlet port 201 is opened in a case where the medium 500 is to be carried in and the shutter 230 of the outlet port 202 is opened in a case where the medium 500 is to be carried out (refer to FIG. 5B).

In addition, in the example shown in FIGS. 5A and 5B, a roll-type shutter 240 is provided as the covering member that covers the heat source 210. The shutter 240 is closed in a case where the shutters 220 and 230 of the inlet port 201 and the outlet port 202 are opened (refer to FIG. 5B). Accordingly, even in a case where the inlet port 201 and the outlet port 202 are opened and thus the internal temperature decreases, a decrease in temperature of the heat source 210 can be suppressed.

Here, in the example shown in FIG. 5B, a state where both the shutter 220 of the inlet port 201 and the shutter 230 of the outlet port 202 are open is shown, but this is for the sake of convenience of description. In actual operation, the shutter 230 of the outlet port 202 is kept closed in a case where the medium 500 is carried in, and the shutter 220 of the inlet port 201 is kept closed in a case where the medium 500 is carried out. As a result, a decrease in internal temperature is suppressed.

Note that the shutters 220, 230, and 240 shown in FIGS. 5A and 5B are examples of the opening and closing members of the inlet port 201 and the outlet port 202 and the covering member of the heat source 210. The configurations of these opening and closing members and the covering member are not limited to the above-described configurations as long as a decrease in internal temperature of the fixation unit 200 or a decrease in temperature of the heat source 210 is suppressed. For example, opening and closing doors may be provided instead of the shutters 220, 230, and 240 shown in FIGS. 5A and 5B. In addition, regarding the opening and closing member of the outlet port 202 through which the medium 500 subjected to a fixation process passes, a configuration in which leakage of internal air is prevented by means of a curtain formed of a heat insulating material or an air curtain may also be adopted.

Here, a case where a metal can (a beverage can) containing a liquid or the like as the content thereof is used as the medium 500 will be considered. In a case where a toner image transferred to the metal can is fixed in a non-contact manner by means of radiant heat from the heat source 210, heat is absorbed by the content of the can, and thus it is difficult for the toner image on a surface of the can to be fixed. In addition, in a case where a method of increasing a fixation temperature is adopted in order to cope with the above-described problem, the temperature of the content increases, and thus the quality of the content may be decreased.

Therefore, in the present exemplary embodiment, a configuration in which light from the heat source 210 is reflected to be applied to a surface of a metal can within a predetermined area is adopted, so that a fixation temperature is secured and a decrease in quality of the content of the metal can is suppressed. A specific description will be made below.

### First Configuration Example of Heat Source 210 (Refer to FIG. 5)

FIGS. 6A and 6B are a view and a graph for description of a first configuration example of the heat source 210 according to the present exemplary embodiment. FIG. 6A is a view showing the light source 250 and the like serving as the heat source 210 provided in the fixation unit 200 together with the medium 500, and FIG. 6B is a graph showing a relationship between a heating time and the surface temperature of the medium 500.

The medium 500 shown in FIG. 6A is a can with a content 503, and is a metal can that is a metal container such as a steel can, an aluminum can, or a tin can. More specifically, examples of the content 503 accommodated in the can include liquid such as water or alcoholic drink. Note that there is also a case where a solid substance is contained as the content 503.

A toner image is transferred to an outer peripheral surface 501 of the medium 500. In addition to a case where the toner image is transferred over the entire circumference of the outer peripheral surface 501, there is also a case where the toner image is transferred to a portion of the outer peripheral surface 501.

In addition, the medium 500 in FIG. 6A showing the first configuration example basically has a columnar shape of which an outer surface is the outer peripheral surface 501. However, the present invention is not limited thereto. The first configuration example can be applied to fixation of a toner image onto an outer surface even in a case where the medium 500 is basically a rectangular parallelepiped of which an outer surface includes a planar portion that is formed to be partially planar, a case where the medium 500 basically has a conical shape and an outer surface thereof is an inclined surface, and the like.

The heat source 210 according to the first configuration example shown in FIG. 6A includes the light source 250 and a reflection plate 260.

The light source 250 is a halogen lamp that is an infrared light source, and light is spread at a predetermined irradiation angle. The light source 250 applies light to the outer peripheral surface 501 of the medium 500 to fix the image G (refer to FIG. 4C) on the outer peripheral surface 501 by means of heat of the light. Note that other examples of the light source 250 include a tungsten lamp, an infrared light emitting diode, or an infrared laser.

The reflection plate 260 is a plate-shaped member that causes light of the light source 250 to be directed to the medium 500. More specifically, the reflection plate 260 includes a concave surface 261 that surrounds a portion of the light source 250 and that reflects the light of the light source 250, and an opening 262 through which the light of the light source 250 including the light reflected by the concave surface 261 passes. It is conceivable to form the reflection plate 260 by using, for example, an aluminum plate, a stainless steel plate, or the like. The reflection plate 260 does not rotate with respect to the light source 250.

In the first configuration example, as shown in FIG. 6A, the concave surface 261 of the reflection plate 260 has a parabolic shape. However, the present invention is not limited thereto.

The opening 262 is positioned on the medium 500 side. The opening 262 is a region through which light from the medium 500 passes and a portion of the light passing through the opening 262 is light reflected by the reflection plate 260 or the entire light passing through the opening 262 is light reflected by the reflection plate 260.

More specifically, the light sources 250 are arranged in a row along a longitudinal direction (a direction perpendicular to the paper surface of FIG. 6A) of the medium 500. In addition, the reflection plate 260 is formed such that the concave surface 261 extends in the longitudinal direction of the medium 500.

Note that, in addition to a configuration in which both end portions of the reflection plate 260 in the longitudinal direction are closed by plate members, a configuration in which the plate members are not provided so that both end portions of the reflection plate 260 in the longitudinal direction are open without the plate members may also be adopted.

The light source 250, the reflection plate 260, and the medium 500 are positioned relatively.

That is, the reflection plate 260 is positioned with respect to the light source 250. More specifically, the reflection plate 260 is positioned such that light of the light source 250 is reflected and the medium 500 is irradiated with the light from the opening 262.

In addition, the medium 500 is positioned with respect to the light source 250 or the reflection plate 260. More specifically, the medium 500 is positioned with respect to the light source 250 or the reflection plate 260 such that the light from the opening 262 is applied to a predetermined area 502 on the outer peripheral surface 501 of the medium 500. The predetermined area 502 described here is a portion of the outer peripheral surface 501 and is an arc portion.

Since the light source 250, the reflection plate 260, and the medium 500 are positioned relatively as described above, the reflection plate 260 reflects wide-spreading light of the light source 250 and concentrates the light in the predetermined area 502 of the medium 500. That is, the reflection plate 260 reflects the light from the light source 250 to the predetermined area 502 on the outer peripheral surface 501 of the medium 500. The light from the light source 250 is not reflected from a portion of the outer peripheral surface 501 other than the predetermined area 502.

In this manner, due to the reflection plate 260, an area at which the light of the light source 250 is reflected from the outer peripheral surface 501 of the medium 500 is limited to the predetermined area 502. An irradiation region is limited by the reflection plate 260.

Here, in a case where a gas such as air is present in the medium 500 in addition to the content 503, a void portion 504 in which the content 503 is not present is present in an internal space of the medium 500. The void portion 504 is a portion of the internal space of the medium 500 and is a region not in contact with the content 503. More specifically, the void portion 504 is a portion interposed between an upper surface of the content 503 and an inner peripheral surface of the medium 500 that corresponds to the predetermined area 502.

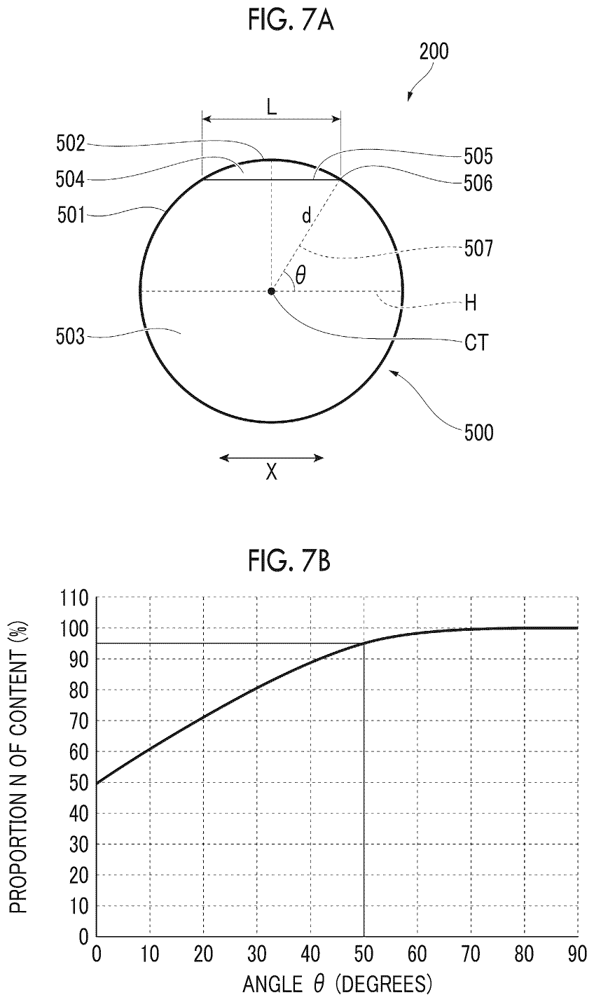

With reference to the void portion 504, the inner peripheral surface of the medium 500 is an arc, and the upper surface of the content 503 is a chord 505 (refer to FIG. 7A) with respect to the arc. A chord length L (refer to FIG. 7A) that is the length of the chord 505 described herein is a width that is the length of the void portion 504 in a direction along an arrow X. Note that since the plate thickness of the medium 500 is small, it can be considered that the chord length L of the void portion 504 is equal to a chord length regarding the predetermined area 502.

The medium 500 is an example of a can, the outer peripheral surface 501 of the medium 500 is an example of a surface of the can, and the content 503 is an example of a content. The light source 250 is an example of a light source unit, and the reflection plate 260 is an example of a reflection portion. The concave surface 261 is an example of a reflection concave surface portion, and the opening 262 is an example of an opening portion.

The graph shown in FIG. 6B shows the result of an experiment regarding a case where the surface of the medium 500 is heated by heat of the light source 250, in which the vertical axis represents a surface temperature S of the outer peripheral surface 501 of the medium 500 and the horizontal axis represents a heating time T (seconds) that is an elapsed time after the start of heating. A case where water is present as the content 503 in the medium 500 is represented by a one-dot chain line, and a case where no water is present in the medium 500 is represented by a broken line. In both of the cases represented by the one-dot chain line and the broken line, the reflection plate 260 shown in FIG. 6A is not provided. In addition, a case where the medium 500 contains water as the content 503 and the reflection plate 260 is provided for the medium 500 is represented by a solid line. The case represented by the broken line will be referred to as “a case where no water is present and no reflection plate is present”, the case represented by the one-dot chain line will be referred to as “a case where water is present and no reflection plate is present”, and the case represented by the solid line will be referred to as “a case where water is present and a reflection plate is present”.

In a case where the surface temperature S of the medium 500 exceeds a fixation-possible temperature S1, the image G (refer to FIG. 4C) on the medium 500 can be fixed.

As is apparent from the graph of FIG. 6B, in the case (represented by the broken line) where no water is present and no reflection plate is present, the fixation-possible temperature S1 is reached in a heating time T1. However, in the case (represented by the one-dot chain line) where water is present and no reflection plate is present, the fixation-possible temperature S1 is not exceeded. This is because the surface temperature is unlikely to rise in a case where water is present.

Meanwhile, in the case (represented by the solid line) where water is present and a reflection plate is present, light is concentrated by the reflection plate and thus the fixation-possible temperature S1 is reached in a heating time T2 (T2>T1).

Here, the temperature of the content 503 of the medium 500 in the experiment shown in FIG. 6B will be described while comparing a case (represented by the one-dot chain line) where water is present as the content 503 but the reflection plate 260 is not present with a case (represented by the solid line) where water is present as the content 503 and the reflection plate 260 is present.

In the case represented by the one-dot chain line, a portion from which light from the light source 250 is reflected is not limited to the predetermined area 502 of the medium 500. Therefore, in a case where the void portion 504 is heated, a portion other than the void portion 504 is also heated in the same manner and the fixation-possible temperature S1 is reached. Therefore, the content 503 is directly heated at the portion other than the void portion 504.

Meanwhile, in the case represented by the solid line, a portion from which light from the light source 250 is reflected is limited to the predetermined area 502 of the medium 500 by the reflection plate 260. Therefore, the light from the light source 250 is not applied to a portion other than the predetermined area 502 that is in contact with the content 503.

Since heat is transmitted through the void portion 504, an increase in temperature of the content 503 may be suppressed in comparison with the case represented by the one-dot chain line. In addition, the predetermined area 502 of the medium 500 can be heated to a temperature, at which fixation can be performed, before the temperature of the content 503 reaches an upper limit value for quality maintenance.

In a case where the opening 262 of the reflection plate 260 is narrowed, the predetermined area 502 from which the light from the light source 250 is reflected is narrowed. Therefore, it is possible to further suppress an increase in temperature of the content 503 by narrowing the predetermined area 502 with respect to the void portion 504 on the assumption that a condition that the fixation-possible temperature S1 is reached is satisfied. As described above, it is possible to cope with a case where a temperature at which a decrease in quality of the content 503 is caused is relatively low.

FIGS. 7A and 7B are a view and a graph for description of the predetermined area 502 on the outer peripheral surface 501 of the medium 500. FIG. 7A is a view for description of the predetermined area 502 and FIG. 7B is a graph showing a relationship between the proportion N of the content 503 in the medium 500 and an angle θ. The proportion N is a value indicating a degree to which the content 503 occupies the internal space of the medium 500 and the angle θ will be described later.

As in the case of the medium 500 shown in FIG. 7A, an equation for obtaining the chord length L of the void portion 504 is L=2d×cos θ.

Here, “d” in the above-described equation is the length of a line 507 connecting a center CT of the medium 500 and an end portion 506 of the chord 505, and is the radius of the medium 500. In addition, “θ” in the above-described equation is an angle formed by the line 507 and a horizontal line H.

As shown in FIG. 7B, the angle θ becomes closer to 90 degrees as the proportion N increases and the angle θ becomes closer to 0 degrees as the proportion N decreases. The proportion N falls in a range of 50% to 100% and the angle θ falls in a range of 0° to 90°.

Here, the proportion N represented by the vertical axis of the graph is a filling percentage, and the filling percentage in the case of a general commercially available product is about 95%. In a case where the filling percentage is 95%, the angle θ is about 50 degrees.

In a case where the calculation is performed by substituting values into the above-described equation, the chord length L is about 1.3d.

As described above, the predetermined area 502 is an area on the outer peripheral surface 501 of the medium 500 from which the light from the light source 250 is reflected. A relationship between the predetermined area 502 of the outer peripheral surface 501 and the chord length L of the void portion 504 will be described. For example, from the viewpoint of suppressing an increase in temperature of the contents 503, it is preferable that the predetermined area 502 is the same as the chord length L instead of being larger than the chord length L. For example, it is more preferable that the predetermined area 502 is smaller than the chord length L so that the increase in temperature is further suppressed.

The above-described equation for obtaining the chord length L is an example of a calculation condition consisting of the diameter of the medium 500 and the filling percentage.

As shown in FIG. 7, a case where the predetermined area 502 is set based on the proportion N, which corresponds to the filling percentage of the content 503, and a radius d, which corresponds to the size of the medium 500, has been described. However, the present disclosure is not limited thereto. For example, a case where the predetermined area 502 is set based on the proportion N and a case where the predetermined area 502 is set based on the radius d are also conceivable.

In addition, it is also conceivable to set the predetermined area 502 based on any one of the posture of the medium 500 or the surface shape of the medium 500. More specifically, regarding the posture of the medium 500, it is conceivable to set the predetermined area 502 in accordance with any of a case where the medium 500 is in an upright state or a case where the medium 500 is in a laid state in a case where the medium 500 has a cylindrical shape.

In addition, regarding the surface shape of the medium 500, it is conceivable to set the predetermined area 502 in accordance with any of a case where the medium 500 has a cylindrical shape, a case where the medium 500 has a prismatic shape including a flat surface portion at a peripheral surface, or a case where the medium 500 has, for example, a conical shape of which a peripheral surface is an inclined surface. In a case where the chord length L is different depending on the position as in the case of a conical shape, the predetermined area 502 may be set to match a smaller chord length L.

In addition, it is conceivable to set the predetermined area 502 based on a combination of two or more of the proportion N, the radius d or a diameter 2d, the posture, and the surface shape of the medium 500, and it is conceivable to set the predetermined area 502 based on any one of the proportion N, the radius d or the diameter 2d, the posture, or the surface shape of the medium 500.

As described above, it is conceivable to set the predetermined area 502 based on at least one of the proportion N, the radius d, the posture, or the surface shape of the medium 500.

### Second Configuration Example of Heat Source 210 (Refer to FIGS. 5A and 5B)

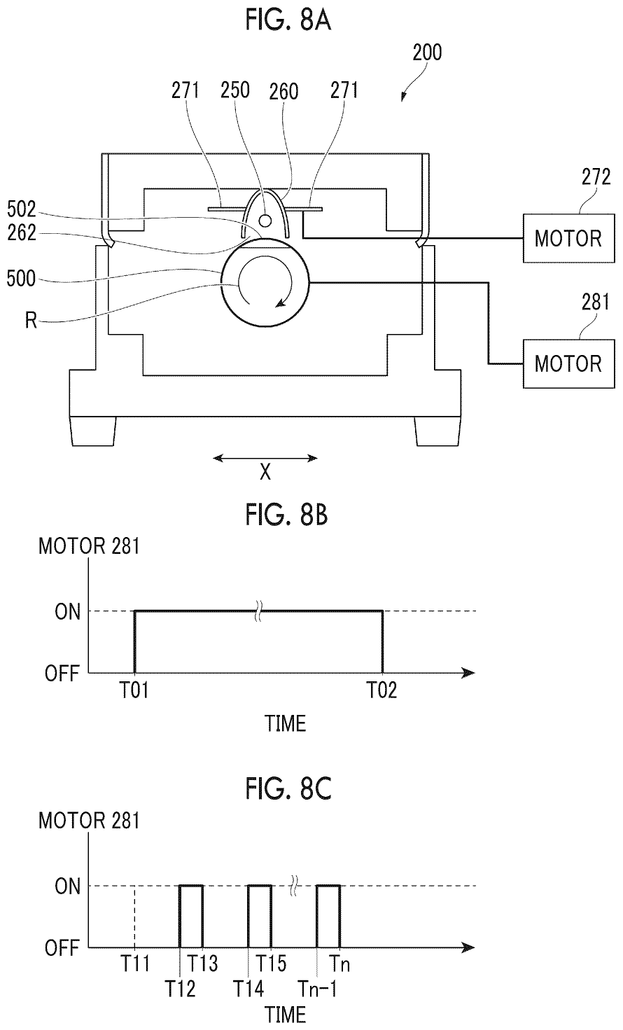

FIGS. 8A to 8C are a view and time charts for description of a second configuration example of the heat source 210 according to the present exemplary embodiment. FIG. 8A is a view showing the light source 250 and the like serving as the heat source 210 together with the medium 500, and FIGS. 8B and 8C are time charts showing operation examples of a motor 281 for rotation of the medium 500. The heat source 210 is provided in the fixation unit 200.

The heat source 210 according to the second configuration example shown in FIG. 8A includes the light source 250 and the reflection plate 260, which are provided in the first configuration example (refer to FIG. 6A) described above, and further includes pressing members 271 and a motor 272.

The pressing members 271 and the motor 272 are components to change the opening 262 of the reflection plate 260. The pressing members 271 are attached to the reflection plate 260. The motor 272 is connected to the pressing members 271.

More specifically, the pressing members 271 are moved in the direction along the arrow X by the driving force of the motor 272, and accordingly, the opening width of the reflection plate 260, which is the width of the reflection plate 260 in the direction along the arrow X at the opening 262, is changed.

Although the size of the predetermined area 502 is increased or decreased due to, for example, a change in diameter of the medium 500, the opening width of the reflection plate 260 is changeable to an opening width corresponding to the predetermined area 502 by the driving force of the motor 272.

Note that the motor 272 operates in a case where the medium 500 is to be provided in the fixation unit 200 and does not operate in the case of fixation performed by the heat source 210.

Here, in the second configuration example shown in FIG. 8A, the motor 281 generating a driving force that rotates the medium 500 is provided. The motor 281 rotates a holding member (not shown) that holds the medium 500. More specifically, the medium 500 is held such that the medium 500 can be rotated in a direction along an arrow R with respect to the heat source 210 by the driving force of the motor 281. The direction along the arrow R is a circumferential direction of the medium 500 and is unidirectional rather than being bidirectional. The direction along the arrow R is an example of a circumferential direction of the can.

In a case where such a configuration in which the motor 281 is provided is adopted, the outer peripheral surface of the medium 500 can be divided into a plurality of parts and the plurality of parts can be heated in order. That is, it is possible to change a heating region by rotating the medium 500 in the direction along the arrow R by means of the motor 281 and to fix an image over a wide area in the circumferential direction of the medium 500.

Note that the size of an image that can be fixed in the first configuration example (refer to FIG. 6A) is equal to or smaller than the size of the predetermined area 502. Meanwhile, in the second configuration example shown in FIG. 8A, it is possible to fix an image having a size exceeding the size of the predetermined area 502.

Note that in a case where the medium 500 is rotated by the motor 281, the upper surface (refer to the chord 505 in FIG. 7A) of the content 503 is made wavy. However, in a case where the proportion of the content 503 is 95%, the magnitude of a wave is supposed to be relatively small since the width of the upper surface is narrow and the wave is supposed to be eliminated in a relatively short time. It is conceivable to cause the motor 281 to operate such that generation of waves is prevented as much as possible.

The way in which the motor 281 operates will be described with reference to FIGS. 8B and 8C. The motor 281 operates in the case of fixation performed by the heat source 210.

In the operation example shown in FIG. 8B, throughout a period between T01 and a time T02, the motor 281 operates and the medium 500 continuously rotates in the direction along the arrow R. The times T01 and T02 are set in accordance with the length of a fixation target image in the direction along the arrow R (that is, the width of the fixation target image) and the speed of rotation. Accordingly, it is possible to cope with a case where the width of the fixation target image is larger than the width of the predetermined area 502 of the medium 500 (for example, a case where an image is formed over the entire circumference of the medium 500).

In the operation example shown in FIG. 8C, the medium 500 is intermittently rotated in the direction along the arrow R. The medium 500 performs intermittent rotation, which is an operation of repeating rotation in one direction and stoppage.

More specifically, in a case where fixation performed by the light source 250 is started at a time T1l, the first fixation is performed during a period between the time T11 and a time T12. In a case where the first fixation is finished, the motor 281 operates throughout a period between the time T12 and a time T13 so that the medium 500 is rotated in the direction along the arrow R. Accordingly, a portion of the outer peripheral surface of the medium 500 from which the light of the light source 250 is reflected is changed.

With heating performed throughout a period between the time T13 and a time T14, the second fixation is performed on a portion different from a portion in the case of the first fixation. In a case where the second fixation is finished, the motor 281 operates throughout a period between the time T14 and a time T15 so that the medium 500 is rotated in the direction along the arrow R. In a case where the final fixation is performed, the motor 281 operates throughout a period between a time Tn−1 and a time Tn. With the motor 281 operating, light emission of the light source 250 is stopped. As described above, a rotating operation of the medium 500 includes entering a rotating state and entering a stopped state.

The period between the time T13 and the time T14 is a time during which the medium 500 stops to rotate and is an example of a predetermined time.

Note that, a modification example in which light emission of the light source 250 is stopped throughout the operation of the motor 281 (for example, throughout the period between the time T12 and the time T13) is also conceivable. In the case of the modification example in which light emission is stopped in such a manner, it is possible to reduce power consumption although a heating time in the case of a restart of the light emission of the light source 250 is long in comparison with a case where the light emission is not stopped.

In other words, in a case where the light emission is not stopped, it is possible to shorten a time in comparison with a case where the light emission is stopped.

In addition, the speed of rotation in the operation example of FIG. 8B in which rotation is continuously performed is lower than the speed of rotation in the case of the operation example shown in FIG. 8C in which rotation is intermittently performed.

It is conceivable to apply the motor 281 provided in the second configuration example to the first configuration example (refer to FIG. 6A).

### Third Configuration Example of Heat Source 210 (Refer to FIGS. 5A and 5B)

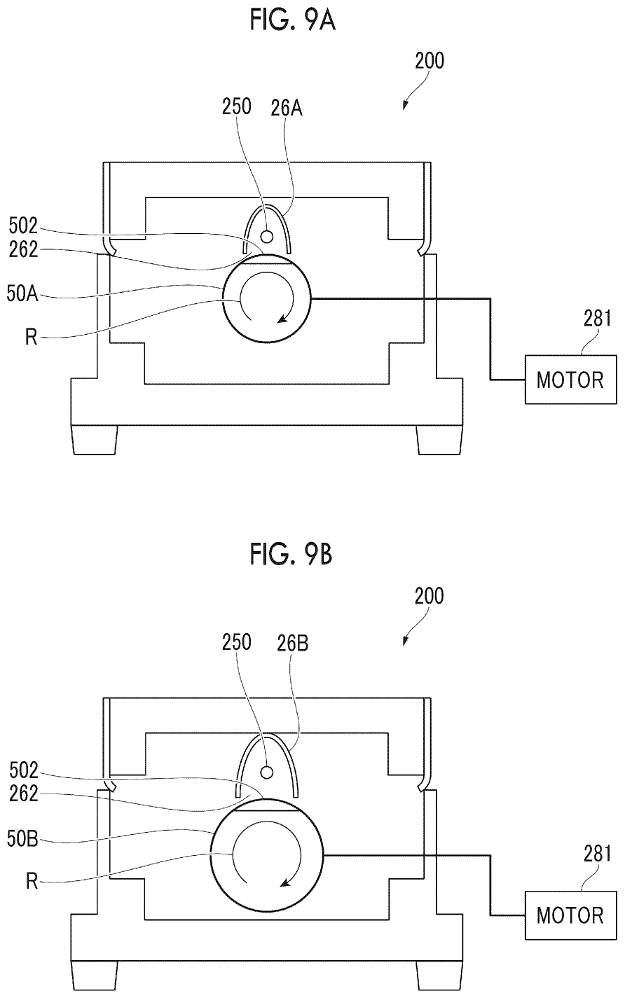

FIGS. 9A and 9B are views for description of a third configuration example of the heat source 210 according to the present exemplary embodiment. FIG. 9A is a view showing a reflection plate 26A constituting a portion of the heat source 210 together with a medium 50A, and FIG. 9B is a view showing a reflection plate 26B constituting a portion of the heat source 210 together with a medium 50B.

The medium 50A in FIG. 9A on which fixation is performed by the fixation unit 200 and the medium 50B in FIG. 9B on which fixation is performed by the fixation unit 200 have different sizes from each other. The outer diameter of the medium 50B is larger than the outer diameter of the medium 50A. Therefore, the predetermined area 502 of the medium 50B is larger than the predetermined area 502 of the medium 50A.

In order to cope with this, in the case of the third configuration example, the reflection plate 26B in FIG. 9B and the reflection plate 26A in FIG. 9A which are different from each other in width of the opening 262 are configured to be replaceable with each other. That is, the reflection plates 26A and 26B having opening widths corresponding to the mediums 50A and 50B are prepared and the reflection plates 26A and 26B are selectively used depending on whether fixation is performed on the medium 50A or the medium 50B.

Any one of the reflection plates 26A and 26B is an example of a reflection portion, and the other is an example of another reflection portion.

Note that in the case of the third configuration example, similarly to the case of the above-described second configuration example (refer to FIG. 8A), the motor 281 is additionally provided and the mediums 50A and 50B can be rotated in the case of fixation. The operation example of the motor 281 is the same as in the case of the second configuration example (refer to FIGS. 8B and 8C).

### First Modification Example

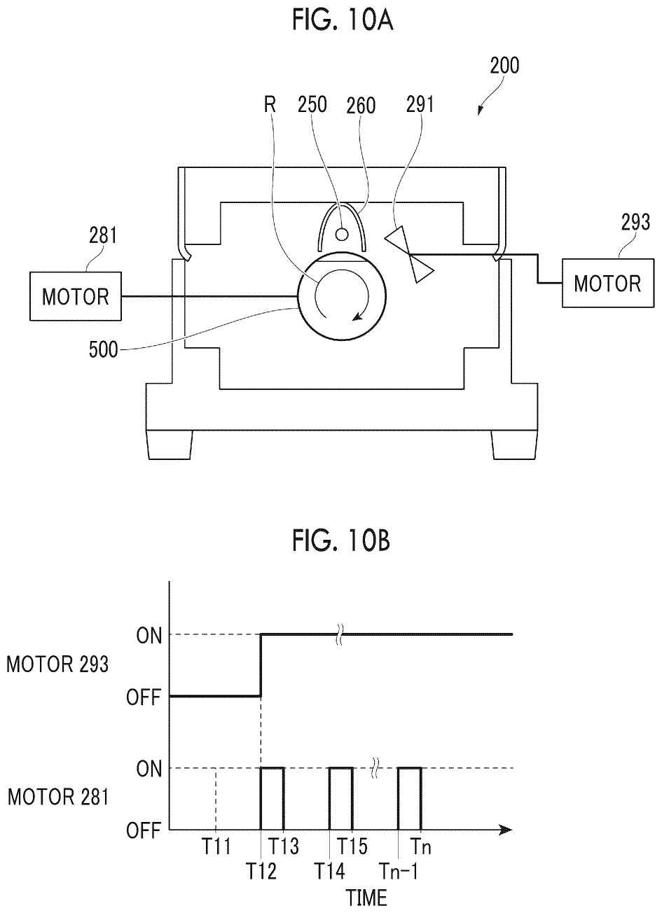

FIGS. 10A and 10B are a view and a time chart for description of a first modification example of the present exemplary embodiment. FIG. 10A is a view showing a configuration in the first modification example, and FIG. 10B is a time chart showing operation examples of the motor 281 and a motor 293.

The motor 281 shown in FIG. 10A is a drive source for rotation of the medium 500 which is described in the second configuration example (refer to FIG. 8A) and as shown in FIG. 10B, the motor 281 operates such that the medium 500 intermittently rotates.

The motor 293 is a drive source for rotation of a fan 291. The fan 291 is provided downstream of, in the direction along the arrow R, a portion that is heated due to the light source 250 and the reflection plate 260 such that fixation is performed thereon and the fan 291 is a member provided to cool the portion after the fixation. The fan 291 lowers the surface temperature of the medium 500 after fixation.

In a case shown in FIG. 10B, at the time T12 at which the first fixation is finished, the motor 293 operates so that the fan 291 starts to rotate. Accordingly, a portion heated during the first fixation is forcibly air-cooled by the fan 291 and thus it is possible to suppress transmission of heat of the medium 500, which is heated in the case of the fixation, to the content 503 (for example, refer to FIG. 6A).

### Second Modification Example

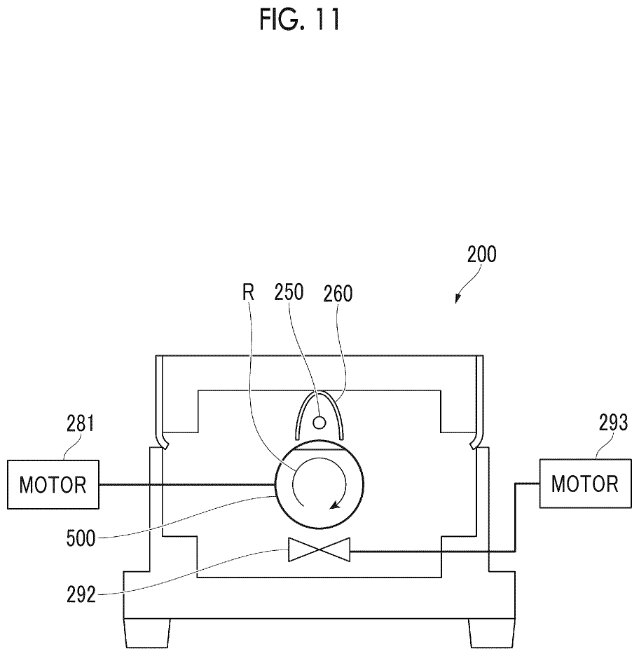

FIG. 11 is a view showing a configuration in a second modification example of the present exemplary embodiment, and corresponds to FIG. 10A described above. Components in the second modification example that are the same as components in the first modification example are denoted by the same reference numerals, and the description thereof may be omitted.

In the second modification example shown in FIG. 11, the fan 291 provided in the first modification example (refer to FIG. 10A) is not provided, and a fan 292 provided at a position different from the position of the fan 291 is provided. More specifically, the fan 292 is provided at a position 180 degrees rotationally offset from the reflection plate 260 in the direction along the arrow R. The fan 292 is rotated by the driving force of the motor 293. The fan 292 is positioned on a side opposite to the heat source 210 and lowers the surface temperature of the fixed medium 500 after fixation.

Since the medium 500 is air-cooled by the fan 292, the heating of the content 503 (for example, refer to FIG. 6A) may be suppressed.

Furthermore, in the case of the fan 292 of the second modification example, the fan 292 is separated from a portion that is heated due to the light source 250 and the reflection plate 260 in comparison with the fan 291 of the first modification example, and thus it is possible to prevent suppression of an increase in temperature caused by heating and to shorten a fixation time.

Note that in the second modification example, as shown in FIG. 11, only the fan 292 is provided. However, another modification example in which the fan 291 (refer to FIG. 10A) provided in the first modification example is also provided is also conceivable. In addition, adopting a configuration in which the rotation speeds of the fans 291 and 292 are the same as each other but the fans 291 and 292 are rotated by different motors so that any one of the fan 291 or the fan 292 is rotated at a higher speed than the other of the fan 291 or the fan 292 is also conceivable.

The fans 291 and 292 and the motor 293 are cooler units that cool the surface of the medium 500 after heating, and are examples of a cooling unit. Note that a configuration in which nozzles that eject air are used instead of the fans 291 and 292 is also conceivable.

In the present exemplary embodiment, a configuration including the light source 250 and the reflection plate 260 having the concave surface 261 as the heat source 210 is adopted (for example, refer to FIG. 6A). However, the present invention is not limited thereto. For example, a configuration further including an optical element such as a lens that utilizes the properties of light is also conceivable.

In addition, in the present exemplary embodiment, the reflection plate 260 constituting a portion of the heat source 210 does not rotate with respect to the light source 250.

In addition, a configuration including, instead of the reflection plate 260, an optical element such as a lens as a portion of the heat source 210 is also conceivable. As the optical element described here, for example, a configuration in which deflection scanning with light from the light source 250 is performed by means of a polygon mirror and a light image is guided to the predetermined area 502 (for example, refer to FIG. 6A) via an fθ lens and a plurality of reflection mirrors is conceivable.

### Supplementary Note

(((1)))

A fixing device comprising:
a light source unit that applies light to a surface of a can accommodating a content so
that an image formed on the surface is fixed by heat of the light; and a reflection portion that reflects the light from the light source unit to a predetermined area on the surface of the can.
   (((2)))

The fixing device according to (((1))),
wherein the reflection portion is configured such that the light of the light source unit is reflected at a reflection concave surface portion and the light reflected at the reflection concave surface portion passes through an opening portion.
   (((3))))

The fixing device according to (((2))),
wherein an opening width of the opening portion is changeable to an opening width corresponding to the predetermined area on the surface of the can.
   (((4)))

The fixing device according to (((2))),
wherein the reflection portion is replaceable with another reflection portion of which an opening portion has a different opening width.
   (((5)))

The fixing device according to any one of (((1))) to (((4))),
wherein the predetermined area is set based on at least one of a size of the can, a posture of the can, a surface shape of the can, or a filling percentage of the content.
   (((6)))

The fixing device according to (((1))),
wherein the reflection portion is not rotatable with respect to the light source unit, and
the can is held to be rotatable in a circumferential direction of the can with respect to the light source unit and the reflection portion.
   (((7)))

The fixing device according to (((6))),
wherein a rotation operation in the circumferential direction of the can includes stopping for a predetermined time.
   (((8)))

The fixing device according to any one of (((1))) to (((7))), further comprising:
a cooling unit that cools at least a portion of an area other than the predetermined area on the surface of the can.
   (((9)))

The fixing device according to (((8))),
wherein the cooling unit is positioned on a side opposite to the can with respect to the reflection portion.
   (((10)))

The fixing device according to (((8))),
wherein the cooling unit is positioned downstream of the reflection portion in a direction of rotation.
   (((11)))

An image forming apparatus comprising:
the fixing device according to (((1))).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a light source unit that applies light to a surface of a can accommodating a content so that an image formed on the surface is fixed by heat of the light; and
a reflection portion that reflects the light from the light source unit to a predetermined area on the surface of the can.

2. The fixing device according to claim 1,
wherein the reflection portion is configured such that the light of the light source unit is reflected at a reflection concave surface portion and the light reflected at the reflection concave surface portion passes through an opening portion.

3. The fixing device according to claim 2,
wherein an opening width of the opening portion is changeable to an opening width corresponding to the predetermined area on the surface of the can.

4. The fixing device according to claim 2,
wherein the reflection portion is replaceable with another reflection portion of which an opening portion has a different opening width.

5. The fixing device according to claim 1,
wherein the predetermined area is set based on at least one of a size of the can, a posture of the can, a surface shape of the can, or a filling percentage of the content.

6. The fixing device according to claim 1,
wherein the reflection portion is not rotatable with respect to the light source unit, and
the can is held to be rotatable in a circumferential direction of the can with respect to the light source unit and the reflection portion.

7. The fixing device according to claim 6,
wherein a rotation operation in the circumferential direction of the can includes stopping for a predetermined time.

8. The fixing device according to claim 1, further comprising:
a cooling unit that cools at least a portion of an area other than the predetermined area on the surface of the can.

9. The fixing device according to claim 8,
wherein the cooling unit is positioned on a side opposite to the can with respect to the reflection portion.

10. The fixing device according to claim 8,
wherein the cooling unit is positioned downstream of the reflection portion in a direction of rotation.

11. An image forming apparatus comprising:
the fixing device according to claim 1.
